(19) United States
(12) Patent Application Publication
(10) Pub. No.: US 2003/0012502 A1
(43) Pub. Date: Jan. 16, 2003

(54) Method for imprinting slanted Bragg gratings into optical fibers and optical fibers produced by such method

(75) Inventors: Isabelle Riant, Orsay (FR); Carlos De Barros, Boulogne-Billancourt (FR); Thierry Lopez, Paris (FR)

Correspondence Address: SUGHRUE, MION, ZINN,, MACPEAK & SEAS, PLLC, 2100 Pennsylvania Avenue, N.W., Washington, DC, 20037-3213, US

(73) Assignee: ALCATEL

(21) Appl. No.: 10/188,080

(22) Filed: Jul. 3, 2002

(30) Foreign Application Priority Data
Jul. 5, 2001 (EP) 01 440 206.9

(51) Int. Cl. G02B 6/34

(52) U.S. Cl. 385/37; 430/290

(57) ABSTRACT

A method for imprinting a plurality of slanted Bragg gratings into a photosensitive optical fiber by exposure of said fiber to a pattern of light shaped in space and/or time and of suitable wavelenth is presented. According to the invention a basic slanted Bragg grating of a determined period is imprinted into said fiber, while, simultanously, a periodic apodisation function is applied to said single slanted Bragg grating. In its preferred embodiment the imprinting light pattern is generated by a phase mask from a UV laser, the phase mask being dithered during the imprinting.

### BACKGROUND OF THE INVENTION

The invention is based on a priority application EP 01 440 206.9 which is hereby incorporated by reference.

The invention relates to a method for imprinting slanted Bragg gratings into photosensitive optical fibers as well as to optical fibers produced by such method.

Bragg gratings in optical fibers have been known to be extremely useful features in the field of telecommunication for quite some years. Versatile filter and reflector systems can be carried out conveniently by use of such gratings. An important application is the optical gain equalisation in long distance fiber lines. In order to compensatate for the loss over long distances optical amplifiers are incorporated into the lines in certain spacial intervals. Unfortunately, in multiplexed systems the amplifier gain usually is not constant over the whole range of all wavelength channels. Thus, a gain equalization by spatially succeeding filter systems is necessary. The filter characteristics, i.e. the “shape” of the filter, has to be optimized according to the characteristics of the fiber line, the amplifier systems and the wavelength range.

Slanted Bragg gratings SBG are used to couple light of certain over amplified wavelengths into the cladding modes of the fiber, while other wavelengths remain unaffected. The SBG is a standard fiber Bragg grating tilted during photo inscription with an angle between the grating fringes and the normal of the fiber axis. This SBG couples most of the fiber-guided mode into radiation modes or cladding modes in a counter-propagating direction. The envelope of couplings into the different cladding modes yields the filter shape. The envelope of couplings is defined by the specific fibre design. It is for example known from FR-A-9806904, to provide a photosensitive cladding to reduce the spectral width of the grating and a reduced photosensitivity in the core to decrease the back reflection, whereby the grating can be short (800 μm) or chirped to suppress the modulation due to coupling into discrete modes. By chirping, varying period fringes along the grating length, or by shortening the grating, each discrete cladding mode is enlarged.

It is often preferred to obtain a high transmission spectrum of the filter. In order to raise the coupling into the different cladding modes by the maximum photo induced refractive index variation of the fiber material, the length of the grating has to be increased or the chirp rate of the grating has to be decreased. However, both methods lead to the disadvantage, that the discrete number of cladding modes induce unwanted discrete unitary filters in the transmission spectrum. Especially in systems of a wide spectral range or in systems with very uneven spectral distribution, however, a single slanted Bragg grating often is not enough to yield a satisfying equalisation of the amplifier gain. Thus, a chain of several slanted Bragg gratings with different characteristics can be concatenated one after the other to represent a row of spatially succeeding filters. The succeeding fiber sections containing one filter each are spliced together. This technique can be used for submarine applications, where no thermal disturbances of the connections are to be expected and where dimension problems don't play an outstanding role. In terrestrial applications, however, the concatenated filters would have to be athermally packaged, which would be technical extremely demanding and would lead to intolerably large packages.

Standard Bragg gratings can be designed in a more complex way, yielding a gain equalization over a wide spectral range using one unique filter easily to be packaged. However, a major drawback of standard Bragg gratings is their back reflectivity, making it necessary to provide for an optical isolator in the optical amplifier.

A method for generating complex standard Bragg gratings is described in U.S. Pat. No. 6,072,926. The Bragg grating is imprinted into a photosensitive optical fiber by exposure of said fiber to a pattern of light shaped in space and in time. A spatial light pattern of interference fringes is generated by sending a primary UV laser beam to a suitably shaped phase mask. The primary laser beam is moved across the phase mask during the imprinting process, which corresponds to a temporal component of the light pattern, the fiber is exposed to. According to the intensity of the interference pattern in certain positions in the photosensitive fiber its refractive index is permanently changed. This leads to a spatial modulation of the fiber's refractive index, namely the Bragg grating.

For sake of the ease of calculation and predictability of the filter's characteristics, it would be desirable to simply superimpose a number of Bragg gratings, each with a different period and if need be with a different modulation depth. They would act independently on the light transmitted by the fiber. Because of reasons of exactness and reproducability of the very small structures of a Bragg grating it is not possible to superimpose several Bragg gratings by simply exposing the same part of the fiber to the imprinting light several times using different phase masks. Even if it was, there would remain the serious drawback of the necessity to carry out as many imprintig steps as there are gratings to be superimposed.

However, the characteristics of the filter based on a Bragg grating can be made more complex by applying a spatial variation of the grating's modulation depth. The grating's modulation depth is the ratio of the amplitude of change of the fiber's refractive index over its constant part, i.e. the refractive index of the undisturbed fiber. The grating's modulation depth can be varied by dithering the phase mask with different magnitudes during the exposure of different parts of the fiber to the imprinting light. The spatial variation of the of the grating's modulation depth is known as apodisation. The concrete shape of apodisation is known as the apodisation function.

A further increase of the filter's complexety is achieved by chirping the grating. A chirp is known to be a variation of the grating's pitch as a function of the linear position on the fiber. U.S. Pat. No. 6,072,926 suggests to vary the distance between the fiber and the phase mask during the imprinting process to achieve the chirp. Alternatively it is known to use so called chirped phase masks. The spatial patterns of such phase masks already include the chirp.

However, so far these methods of shaping the filter cannot provide all the advantages of a simple superposition of a plurality of gratings.

### SUMMARY OF THE INVENTION

It is a particular object of the current invention to provide a method to simultanously imprint superimposed slanted Bragg gratings into a photosensitive optical fiber while being able to use aproved techniques.

To this end it is suggested, according to the invention, to imprint a basic slanted Bragg grating of a determined period into the photosensitive fiber and simultanously apply a periodic apodisation function to the grating, where the period of the apodisation function is smaller than the grating's basic period. This is exactly equivalent to a true superposition of several slanted Bragg gratings. The optical characteristics of the filter system achieved this way is equivalent to the one of a filter system composed from several slanted Bragg gratings of different periods and, according to the special shape of the periodic apodisation function, also of different modulation depth. So far a filter characteristics like this could only be achieved by concatenation of the different Bragg gratings in spatial succession. However, a filter system according to the invention does not suffer from the above mentioned drawbacks of package size and temperature sensitivity.

The equivalence between a plurality of truely superimposed slanted Bragg gratings (e.g. by repeated exposure of the same part of the fiber to the light patterns generated by different phase masks one after the other) can be understood by looking to the simple example of superimposing two slanted Bragg gratings of the same the respective periods Λ₁ and Λ₂. Each grating represents a periodic modulation of the fiber's refractive index. Like any periodic function each grating can be expanded into it's Fourier series. For the sake of simplissity only the first order terms shall be regarded. However, in most cases the actual modulation of the fiber's refractive index, representing the grating, is almost purely sinusoidal. At least in those cases the higher order terms of the Fourier expansion can truely be neglected.

Bragg grating 1: Bᵢ˜sin(2π·x/Λ₁) (1a)

Bragg grating 2: B₂˜sin(2π·x/Λ₂), (1b)

where x represents the spatial position along the fiber. As the concrete amplitudes of change of the refractive index are of no special concern here, they have been dropped and replaced by the proportionality sign “˜”.

Mathematically a superposition corresponds to an addition. From the well known formula

sin a+sin b=2 sin{½(a+b)}cos{½(a−b)} (2)

it can be calculated:

$$\begin{matrix}{B}_{1} + {B}_{2} ∼ sin ( 2 π \cdot x / {Λ}_{1} ) + sin ( 2 π \cdot x / {Λ}_{2} ) \\ = 2 sin \{ π x ( 1 / {Λ}_{1} + 1 / {Λ}_{2} ) \} cos \{ π x ( 1 / {Λ}_{1} - 1 / {Λ}_{2} ) \} \\ = 2 sin \{ 2 π \cdot x / {Λ}_{i} \} cos \{ 2 π \cdot x {Λ}_{b} \} ,\end{matrix} \qquad ( 3 )$$

where the intermediate period

Aᵢ=2Λ₁Λ₂/(Λ₁+Λ₂) (4)

and the beat period

A_{b}=2 Λ₁AΛ₂/(Λ₁−Λ₂). (5)

The formula (3) clearly shows, that the superposition of to slanted Bragg gratings of periods Λ₁ and Λ₂ yields one basic grating of the intermediate period Λᵢ, apodized sinusoidally with beat period Λ_{b}. This can be compared to an electromagnetic carrier frequency (corresponding to the basic grating of period Λᵢ), amplitude modulated with the lower beat frequency (corresponding to the sinusoidal apodisation function of beat period Λ_{b}). Because of the linear characteristics of the Fourier expansion the above calculation is valid also for the higher order terms, which, thus, don't have to be regarded individually, if they have to be considered at all.

The formula (3) does not exactly represent the experimental condition, but is only a simple model, that illustrates the fundamental features. The formula (3) has been found by not only neglecting the higher order terms of the Fourier expansion (which is justified in most cases), but also by assuming the zeroth order term to vanish (see formulas (1a) and (1b)). This not true. The imprinting light makes the local refractive index vary from the undisturbed value in only one direction, usually increasing it. Thus the the modulation depth of a Bragg grating is allway smaller than 1. Furthermore the formula (3) assumes the equality of the amplitudes of change of the refractive index in both the Bragg gratings. This is not necessary and in most real cases even not desirable, because different wavelengths would need different amounts of coupling to the cladding modes. In order to compensate for this an offest and a decrease of the apodsation function's amplitude would have to be introduced into the formula (3). However, the fundamental statement, namely the equivalence between two superimosed gratings with one basic grating apodized sinusoidally, remains true.

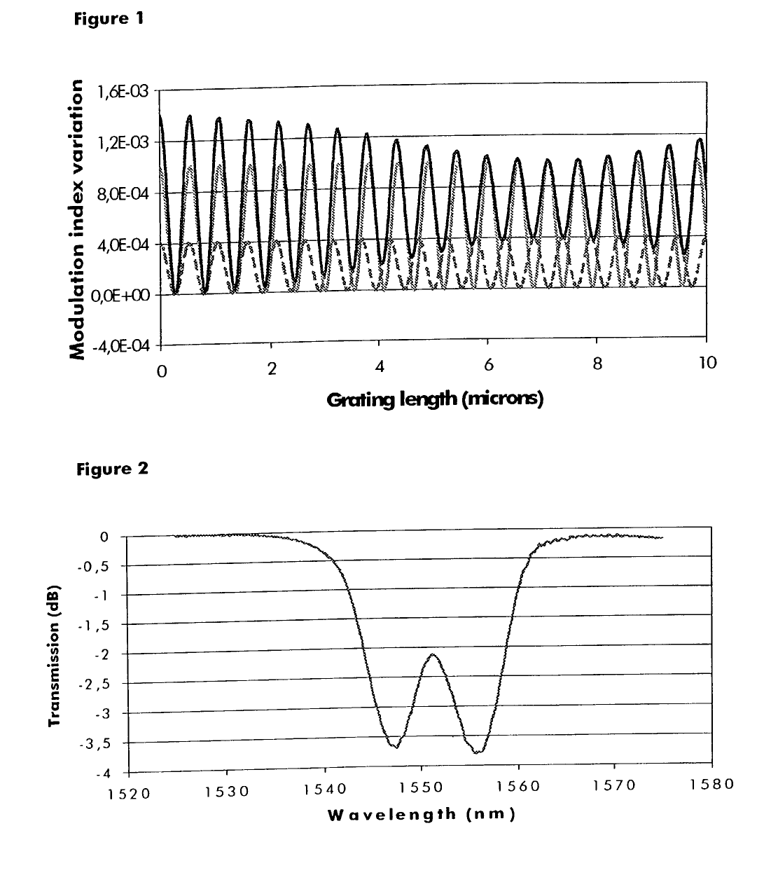

FIG. 1 shows the calculated graphs of a more realistic case: a first, weak grating (grating 1) of period Λ₁=0,524 μm with a modulation depth of 2·10⁻⁴ has been superimposed with a second, stronger grating (grating 2) of period Λ₂=0,542 μm with a modulation depth of 5·10⁻⁴. FIG. 1 also shows the superimposed grating of the basic period Λᵢ=0,533 μm modulated sinusoidally with the beat period Λ_{b}=31,556 μm.

More complex filter systems can be achieved by applying a more complex, though still periodic apodisation function to the basic grating. This is equivalent to the superposition of more than two gratings. The concrete form of the periodic apodisation function can be achieved by trigonomic calculations analogue to the kind demonstrated above.

The invented method can be carried out using known techniques. This is an important advantage, because existing instrumentation can be used, being an important cost factor. It is preferred to imprint the basic Bragg grating using the phase mask technique explained above. The periodic apodisation function is preferably applied by dithering the phase mask during the exposure using a piezo-electric stage. If a chirp is to be applied, it is preferred to use a chirped phase mask.

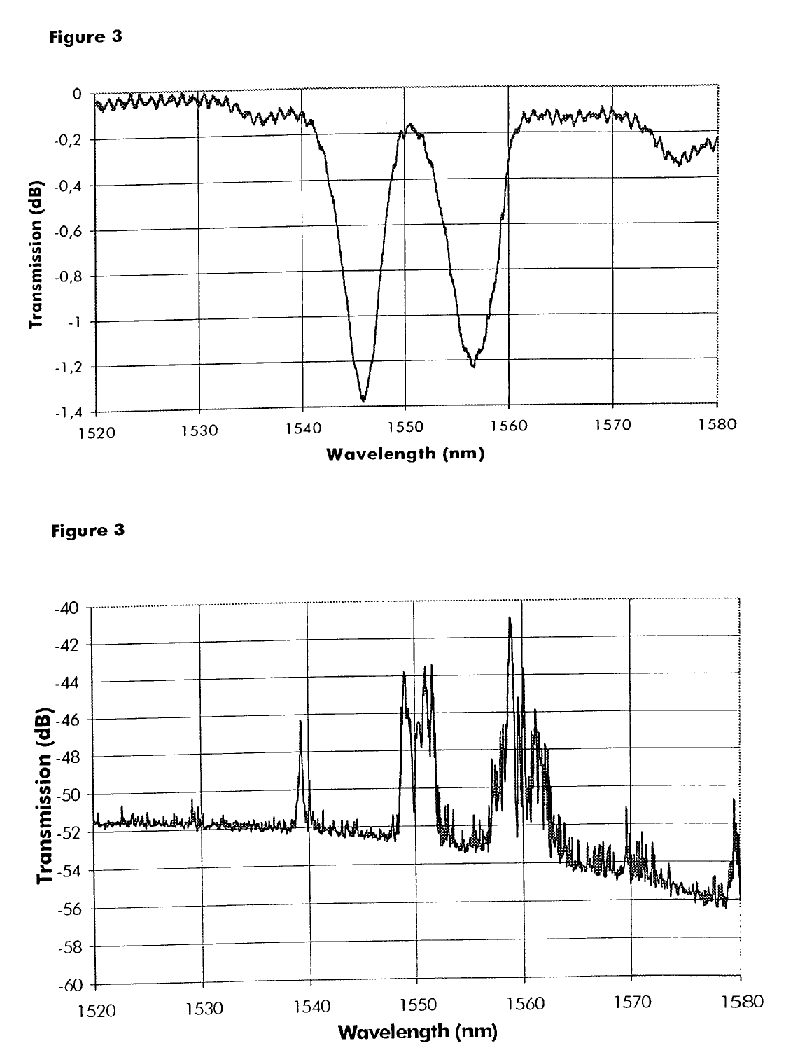

FIG. 2 shows the transmission spectrum of a slanted Bragg grating filter, that had been created using the invented method in its preferred embodyment, according to the specifications of FIG. 1. Two peaks of efficent outcoupling to the cladding modes can clearly be distinguished. So far, such a filter characteristics was only achievable by two independent filter systems. Thanks to the invention now a single and easy to produce filter can be used.

A further increase of the filter's complexity, can be achieved by additionally applying a chirp to the basic grating.

To improve the the coupling into the filter system, the fiber can be tapered to minimize coupling losses.

Apart from the preferred embodyment there are other ways to carry out the invention. The chirp, e.g. can be applied by variation of the distance between a non-chirped phase mask and the fiber during exposure. Also, rather than using a phase mask, it is possible to imprint the grating point by point using a split laser beam. Finally the apodisation function can be applied by variation of the laser intensity, rather than by dithering the phase mask.

1. A method for imprinting a plurality of slanted Bragg gratings into a photosensitive optica fiber by exposure of said fiber to a pattern of light shaped in space and/of suitable wavelength, wherein
a basic slanted Bragg grating of a determined period is imprinted into said fiber, while, simultanously, a periodic apodisation function is applied to said single slanted Bragg grating.

2. A method according to claim 1, wherein the periodic apodisation function depends sinusoidally on the spatial distance from either end of the slanted Bragg grating.

3. A method according to claim 1, wherein the period of the basic slanted Bragg grating is chirped.

4. A method according to claim 1, wherein a phase mask is used to generate the imprintig light pattern from a laser beam.

5. A method according to claim 4, wherein the periodical apodisation function is generated by dithering the phase mask appropriately during the imprinting process.

6. A method according to claim 5, wherein the phase mask is dithered by a piezo-electric stage.

7. A method according to claim 3, wherein a chirped phase mask used.

8. A method according to claim 1, wherein a tapered fiber is used.

9. An optical fiber carrying at least one plurality of slanted Bragg gratings, imprinted into said fiber by a method according to one of the predecendent claims.
